(19) United States
(12) Patent Application Publication
(10) Pub. No.: US 2014/0097614 A1
(43) Pub. Date: Apr. 10, 2014

(54) JOINT FASTENING STRUCTURE

(71) Applicant: Bin Chen, Shenzhen City (CN)

(72) Inventor: Bin Chen, Shenzhen City (CN)

(73) Assignee: ASIA VITAL COMPONENTS (CHINA) CO., LTD., Shenzhen City (CN)

(21) Appl. No.: 13/647,619

(22) Filed: Oct. 9, 2012

(51) Int. Cl. F16L 19/00

(52) U.S. Cl. 285/344

(57) ABSTRACT

A joint fastening structure includes a first tube, a second tube, and at least one insert member. The first tube is provided at one end with a coupling section, on which at least one sealing portion and at least one locating portion are formed, and the sealing portion is configured for a sealing ring to fit therein. The second tube has a passageway for the coupling section to insert thereinto, and is formed on one side with at least one insertion portion. The insert member is inserted in the insertion portion to partially extend into the passageway in the second tube and engage with one side of the locating portion. With the above arrangements, the first and second tubes can be more conveniently coupled to each other with improved sealing effect between them, while the first tube is turnable relative to the second tube.

### FIELD OF THE INVENTION

The present invention relates to a joint fastening structure, and more particularly to a joint fastening structure that provides improved sealing effect and can be more conveniently assembled.

### BACKGROUND OF THE INVENTION

The currently commercially available turning joints are widely applied to many fields, such as medical, metallurgical, chemical engineering, and electrical appliance fields. Turning joints can be assembled in many ways. According to one of the ways for assembling turning joints, one tube is fitted in another tube, and screws are threaded through the joint between the two tubes to fasten them to each other. However, once the two tubes are screwed together at the joint, they are no longer turnable relative to each other. This would narrow the applications of the turning joints. Further, two tubes locked together only by screws normally provide poor sealing effect between them.

FIGS. 1A and 1B shows another conventional joint fastening structure 1, which includes at least one first tube 10 and at least one second tube 11. The first tube 10 is provided around an end with external threads 101 while the second tube 11 is provided at an end with an internally threaded coupling section 111 for engaging with the external threads 101. By screwing the external threads 101 of the first tube 10 to the internally threaded coupling section 111 of the second tube 11, the first tube 10 and the second tube 11 are tightened together. However, this way of assembling turning joints involves many parts and requires additional tools to facilitate the assembling of the first and second tubes 10, 11, and accordingly increases the manufacturing cost and is less convenient in assembling.

In brief, the conventional turning joints and joint fastening structures have the following disadvantages: (1) poor sealing effect; (2) uneasy to assemble; (3) increased manufacturing cost; and (4) narrowed range of applications.

It is therefore tried by the inventor to develop an improved joint fastening structure to effectively solve the problems in the conventional turning joints and joint fastening structures.

### SUMMARY OF THE INVENTION

A primary object of the present invention is to provide a joint fastening structure that enables enhanced sealing effect.

Another object of the present invention is to provide a joint fastening structure that can be more conveniently assembled.

A further object of the present invention is to provide a joint fastening structure that can be produced at reduced manufacturing cost.

To achieve the above and other objects, the joint fastening structure according to the present invention includes a first tube, a second tube and at least one insert member. The first tube is provided at one end with a coupling section, on which at least one sealing portion and at least one locating portion are formed, and the sealing portion is configured for a sealing ring to fit therein. The second tube has a passageway for the coupling section to insert thereinto, and is formed on one side with at least one insertion portion extended into the second tube and communicating with the passageway and the locating portion. The insert member is inserted in the insertion portion to extend into the passageway and engage with one side of the locating portion.

In an embodiment of the present invention, there are two insertion portions extended into the second tube to symmetrically locate at two opposite lateral sides of the passageway, and the insertion portions respectively include an open section; wherein the insertion portions are communicable with the passageway and the locating portion via the open sections.

To use the above-described joint fastening structure, first put the sealing ring around the sealing portion of the first tube and then insert the coupling section of the first tube into the passageway of the second tube. When the first tube is inserted into the passageway of the second tube, the sealing ring fitted in the sealing portion is compressed by the second tube for the first tube to firmly fit in the passageway of the second tube and accordingly provides largely upgraded sealing effect. Finally, insert the insert member into the insertion portion. Since the insert member is partially located in the passageway via the open section on the insertion portion to engage with one side of the locating portion, the first tube coupled to the second tube is freely turnable relative to the second tube by 360 degrees.

With the above arrangements, the joint fastening structure of the present invention can be more conveniently assembled and requires only reduced manufacturing cost while having a wide range of applications.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1A is an exploded perspective view of a conventional joint fastening structure;

FIG. 1B is an assembled view of FIG. 1;

FIG. 2A is an exploded perspective view of a joint fastening structure according to a first embodiment of the present invention;

FIG. 2B is an assembled view of FIG. 2A;

FIG. 2C is a perspective sectional view of the joint fastening structure according to the first embodiment of the present invention;

FIG. 2D is a plan sectional view of the joint fastening structure according to the first embodiment of the present invention;

FIG. 3 is a perspective sectional view showing the rotating movement of the joint fastening structure according to the first embodiment of the present invention; and

FIG. 4 is an exploded perspective view of a joint fastening structure according to a second embodiment of the present invention.

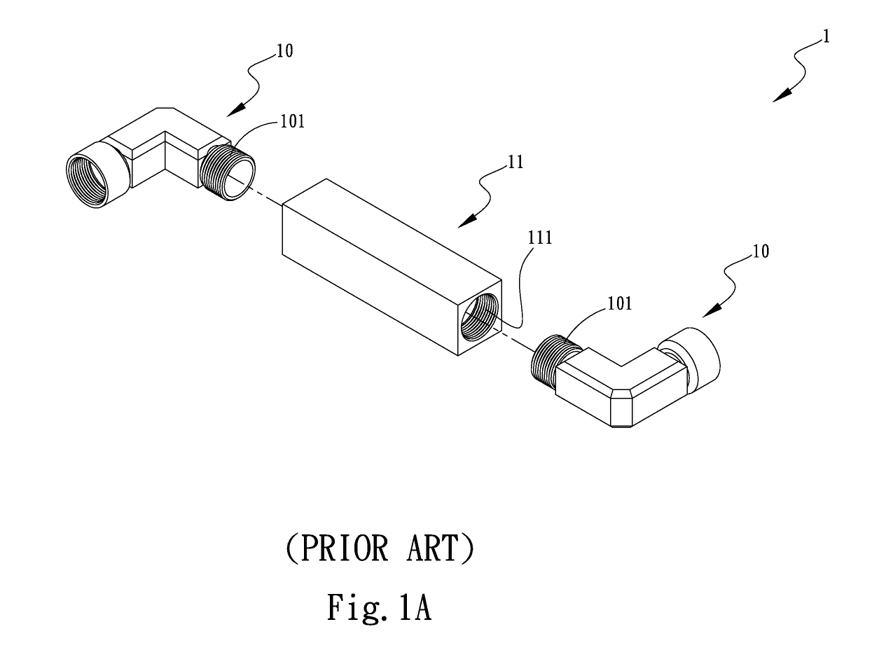

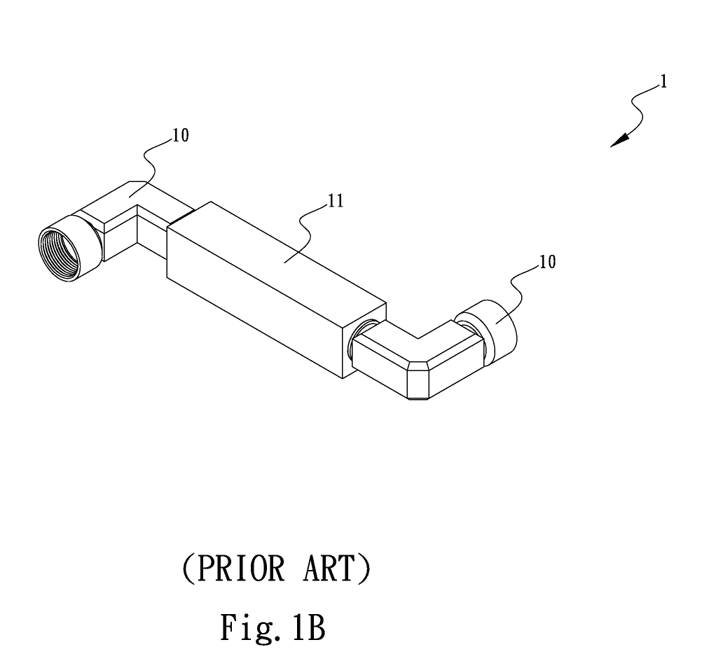

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

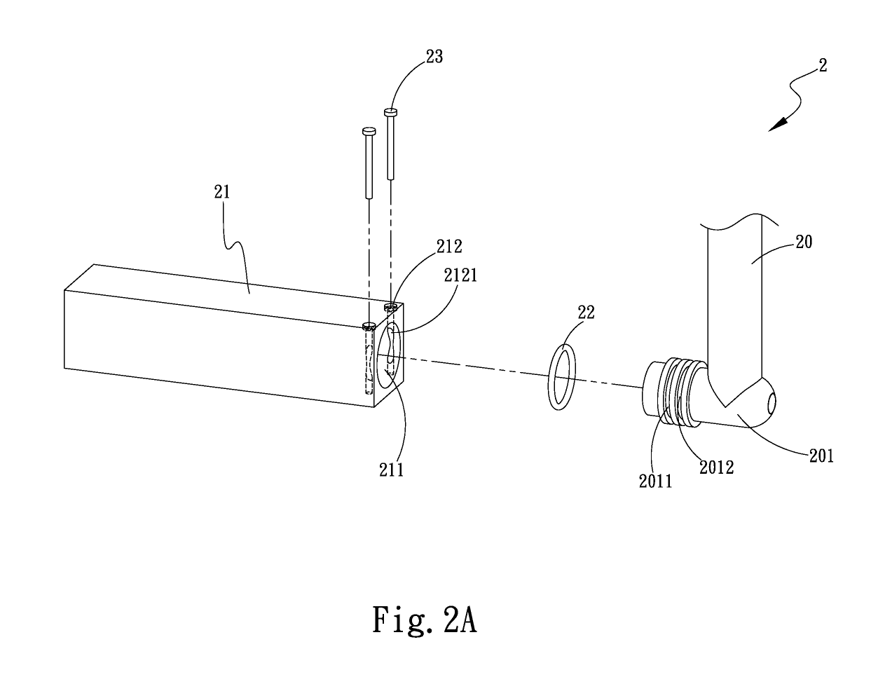

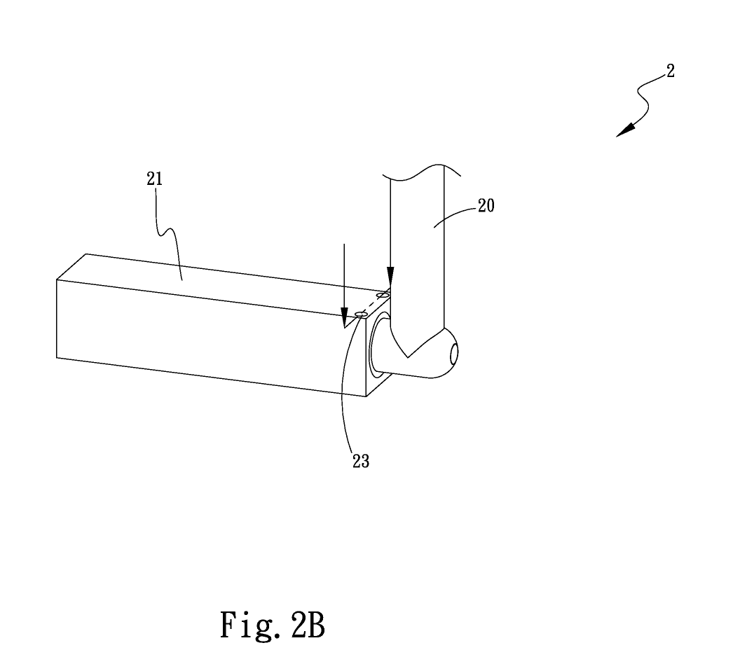

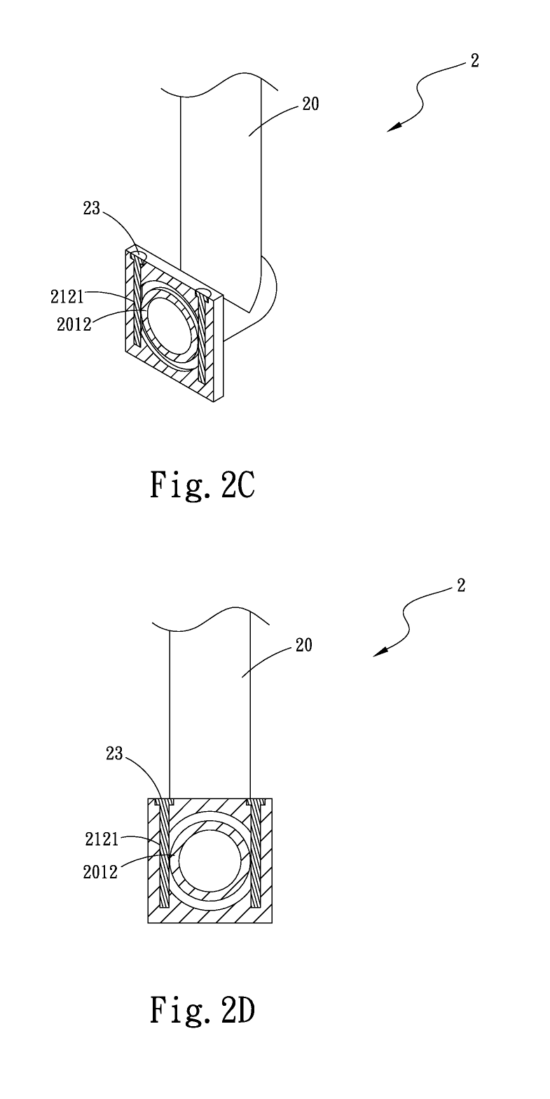

Please refer to FIGS. 2A and 2B that are exploded and assembled perspective views, respectively, of a joint fastening structure 2 according to a first embodiment of the present invention; and to FIGS. 2C and 2D that are perspective and plan sectional views, respectively, of the joint fastening structure 2 of FIG. 2B. As shown, in the first embodiment, the joint fastening structure 2 includes a first tube 20, a second tube 21, and at least one insert member 23. The first tube 20 is provided at one end with a coupling section 201, on which at least one sealing portion 2011 and at least one locating portion 2012 are formed. The sealing portion 2011 and the locating portion 2012 are parallelly formed around an outer surface of the coupling section 201. The sealing portion 2011 is configured for a sealing ring 22 to fit therein. In a preferred embodiment of the present invention, the first tube 20 is an L-shaped tube having a shorter and a longer part, and the coupling section 201 is provided on the shorter part of the L-shaped tube; and the second tube 21 can be a square tube without being particularly limited thereto.

The second tube 21 has a passageway 211 for the coupling section 201 to insert thereinto. Further, the second tube 21 is formed on one side wall with at least one insertion portion 212. In the illustrated first embodiment, two insertion portions 212 are symmetrically formed on two lateral sides of the passageway 211 corresponding to the locating portion 2012 on the first tube 20. Each insertion portion 212 includes an open section 2121 communicating with the passageway 211 and the locating portion 2012. In practical implementation of the present invention, the insertion portion 212 is an insertion slot.

The insert member 23 is inserted in the insertion portion 212 to extend into the passageway 211, such that a middle section of the insert member 23 is exposed from the insertion portion via the open section 2121 to engage with one side of the locating portion 2012.

To use the above-described joint fastening structure 2, first put the sealing ring 22 around the sealing portion 2011 of the first tube 20 and then insert the coupling section 201 of the first tube 20 into the passageway 211 of the second tube 21 to thereby couple the first and the second tube 20, 21 to each other. When the first tube 20 is inserted into the passageway 211 of the second tube 21, the sealing ring 22 fitted in the sealing portion 2011 is compressed by the second tube 21 for the first tube 20 to firmly fit in the passageway 211 of the second tube 21 and accordingly provides largely upgraded sealing effect. Finally, the insert member 23 is inserted into the insertion portion 212.

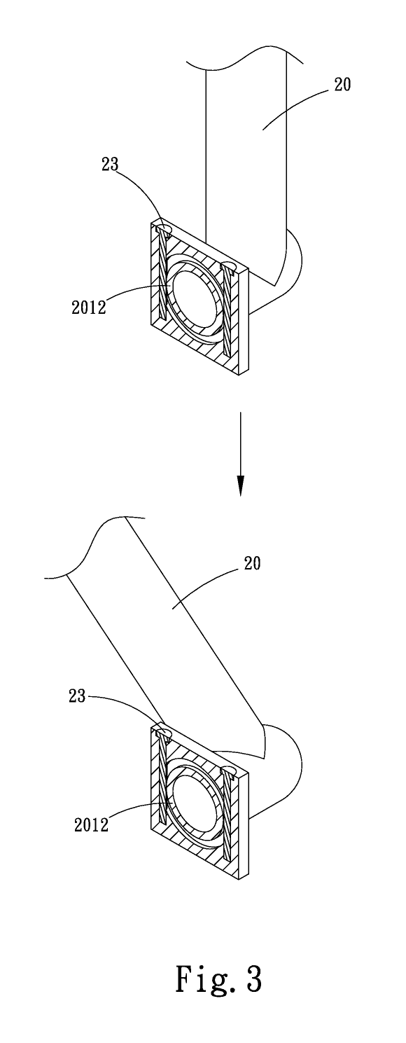

Please refer to FIG. 3. The insert member 23 is configured for inserting into the insertion portion 212 of the second tube 21. Since the insertion portion 212 is formed on the lateral side of the passageway 211 corresponding to the locating portion 2012 on the first tube 20 and each insertion portion 212 includes an open section 2121 communicable with the passageway 211 and the locating portion 2012, the middle section of the insert member 23 inserted in the insertion portion 212 is exposed from the insertion portion 212 via the open section 2121 to engage with one side of the locating portion 2012. With the insert member 23 engaged with one side of the location portion 2012, the first tube 20 coupled to the second tube 21 is allowed to freely rotate relative to the second tube 21 by 360 degrees. Therefore, the joint fastening structure 2 according to the present invention not only enables convenient coupling of two tubes to each other and reduced manufacturing cost, but also has a wide range of applications.

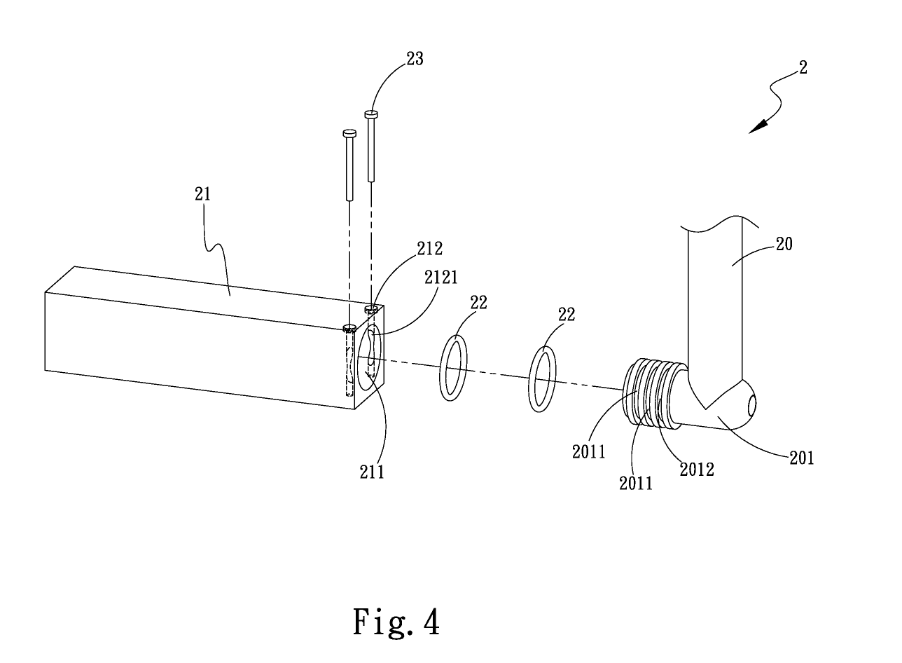

FIG. 4 is an exploded perspective view of a joint fastening structure 2 according to a second embodiment of the present invention. As shown, the joint fastening structure 2 in the second embodiment is generally structurally similar to the first embodiment, except that, in the second embodiment, two sealing portions 2011 are provided on the coupling section 201 and two sealing rings 22 are separately fitted around the two sealing portions 2011. To use the joint fastening structure 2 of the second embodiment, first put the sealing rings 22 around the sealing portions 2011 and then insert the coupling section 201 of the first tube 20 into the passageway 211 of the second tube 21, so as to couple the first and the second tube 20, 21 to each other. When the first tube 20 is inserted into the passageway 211 of the second tube 21, the sealing rings 22 fitted in the sealing portions 2011 are compressed by the second tube 21 for the first tube 20 to firmly fit in the passageway 211 of the second tube 21 and accordingly provide a largely upgraded sealing effect. Finally, the insert member 23 is inserted into the insertion portion 212.

Compared to the prior art, the joint fastening structure according to the present invention has the following advantages: (1) providing high sealing effect; (2) easy to assemble; (3) reduced manufacturing cost; and (4) wide applications.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A joint fastening structure, comprising:
a first tube being provided at one end with a coupling section, on which at least one sealing portion and at least one locating portion are formed; and the sealing portion being configured for a sealing ring to fit therein;
a second tube having a passageway for the coupling section to insert thereinto, and being formed on one side with at least one insertion portion extended into the second tube; and the insertion portion being communicable with the passageway in the second tube and the locating portion on the first tube; and
at least one insert member being inserted in the insertion portion to extend into the passageway and engage with the locating portion.

2. The joint fastening structure as claimed in claim 1, wherein the sealing portion and the locating portion are parallelly formed around an outer surface of the coupling section.

3. The joint fastening structure as claimed in claim 1, wherein the first tube is an L-shaped tube having a shorter and a longer part, and the coupling section being provided on the shorted part of the L-shaped first tube.

4. The joint fastening structure as claimed in claim 1, wherein there are two insertion portions extended into the second tube to symmetrically locate at two opposite lateral sides of the passageway.

5. The joint fastening structure as claimed in claim 4, wherein the insertion portions respectively include an open section, and the insertion portions being communicable with the passageway and the locating portion via the open sections.

6. The joint fastening structure as claimed in claim 5, wherein the insertion portions are insertion slots; and the insert member inserted in each of the insertion portions having a middle section exposed from the insertion portion via the open section to engage with one side of the location portion.
